(19) United States
(12) Patent Application Publication
(10) Pub. No.: US 2006/0176550 A1
(43) Pub. Date: Aug. 10, 2006

(54) Tube for a viewing device as well as a viewing device

(76) Inventors: Christian Luecke, Oberkochen (DE); Fritz Straehle, Heubach (DE)

Correspondence Address: KRIEGSMAN & KRIEGSMAN, 665 Franklin Street, Framingham, MA, 01702, US

(21) Appl. No.: 11/389,631

(22) Filed: Mar. 27, 2006

Related U.S. Application Data
(60) Provisional application No. 60/771,148, filed on Feb. 7, 2006.

(30) Foreign Application Priority Data
Feb. 7, 2005 (DE) 102005005568.0

(51) Int. Cl. G02B 21/00

(52) U.S. Cl. 359/380; 359/432

(57) ABSTRACT

Described is a tube (20) for a viewing device (10), particularly for a microscope, the tube (20) having at least one viewing beam path—for example, two viewing beam paths (21, 22). Provided in the at least one viewing beam path is at least one optical tube element. In order to reduce the structural length of the viewing device (10), it is provided for in accordance with the invention that a magnification system (23) for changing the focal depth—for example, a zoom system—is further arranged in the viewing beam path of the tube (20) itself. In the case of several viewing beam paths, a magnification subsystem (24, 25) for changing the focal depth can be arranged, for example, in each of the viewing beam paths (21, 22) of the tube. Further described is a corresponding viewing device (10).

The present invention relates first of all to a tube for a viewing device in accordance with the preamble of patent claim 1. Further, the invention also relates to a viewing device, which can involve, for example, a microscope.

Viewing devices in the form of microscopes are employed in diverse fields. Involved in one area of application is surgical microscopy, for example.

A microscope consists, in general, of a number of basic components. What is involved, in general, is the base unit as well as the attached tube.

In a number of applications, such as, for example, in neurosurgical operations, there often arise situations in which the surgical microscope is employed more or less horizontally, that is, with straight-on viewing of the tube, in which cases a swivel tube is often involved. In such a case, on account of the structural length of the complete surgical microscope, an ergonomic operation for the surgeon is practically impossible. He is often compelled to operate with his arms more or less extended.

Therefore, there exists the need to reduce the structural length of such a microscope.

Already known from DE 103 16 242 A1 is a movable tube, a so-called swivel tube, by means of which the structural length of a microscope can be reduced. To this end, the tube has a deviation system for deflecting the viewing beam paths. The viewing beam paths enter the tube parallel to an optical axis and are deflected by means of suitable optical elements in a direction perpendicular to this optical axis. In the viewing beam paths that run perpendicular to the optical axis, it is possible to provide lenses or lens systems, these involving so-called tube lenses. These lenses are immovable and are thus arranged in fixed position in the viewing beam paths. The known solution thus represents a tube having a fixed focal depth.

Often, in the case of microscopes of the kind mentioned, it is desirable to provide a magnification system for changing the focal depth. This can involve, for example, a zoom system or the like. The use of magnification systems of this kind is in itself already known from the prior art. The magnification system is always employed there as an independent module that is separate from the tube. Magnification systems of the known kind have so far been arranged in the base unit of the microscope. Such a solution is described, for example, in DE 102 55 961 B3.

Described in this publication is a stereomicroscope that has a main objective and a zoom system in its base unit. Arranged next on the base unit is a binocular tube having eyepieces. The optical axis of the main objective should run vertically, whereas the central axis of the zoom system should run horizontally. The deviation of the viewing beam path occurs by means of a deviating element.

In this known solution, the zoom system is located in the base unit of the microscope, as in the case for all known, previously realized solutions of the prior art. As a result, the magnification or the change in the focal depth takes place before the viewing beam path reaches the tube, because the tube still has to be placed on the base unit in this known solution.

Starting from the prior art mentioned, the present invention is based on the problem of further developing a tube or a viewing device of the kind mentioned above in such a way that the required structural length of a viewing device in which the tube is used can be further reduced.

This problem is solved in accordance with the invention by way of the tube having the features according to the independent patent claim 1 as well as the viewing device having the features according to the independent patent claim 20. Additional advantages, features, and details of the invention ensue from the subclaims, the description, and the drawings. Advantages, features, and details that are described in connection with the tube of the invention obviously apply as well in connection with the viewing device of the invention and vice versa.

The present invention is based on the knowledge that the magnification system is no longer to be arranged in the base unit of the viewing device but rather instead in the tube itself.

Provided according to a first aspect is a tube for a viewing device, particularly for a microscope, the tube having at least one viewing beam path and at least one optical tube element being arranged in the viewing beam path. According to the invention, the tube is characterized in that, in the viewing beam path of the tube, a magnification system for changing the focal depth is also arranged.

By shifting the magnification system from the base unit of the viewing device into the tube, it is possible to achieve an even greater effect with respect to a reduction in structural length than is possible, for example, by the shortening of the structural length of the swivel tube described in DE 103 16 242 A1.

The design according to the invention results in a reduction in the structural length of the complete viewing device by at least the length of the magnification system. Depending on the magnification factor, the reduction in the structural length can lie on the order of magnitude of about 50 to 70 mm.

As has already been discussed further above, it has been common up to now to provide the magnification system within the base unit of a viewing device. The tube was then arranged on this base unit. In particular, when the tube involved a swivel tube, it was possible to realize an inexpensive solution that was simple in terms of construction. Namely, magnification systems, as a rule, consist of a number of optical components, such as, for example, lens elements or lens element systems, that are movable at least in. part. The shifting of the magnification system into the tube makes it possible to achieve, among other things, improved ergonomic relationships. This is particularly true when the viewing device takes the form of a surgical microscope employed in neurosurgery and is used, in extended assembly, with straight-on viewing of the tube - for example, of a swivel tube.

Surprisingly, it has now become possible to circumvent the realization variants commonly employed up to now among practitioners and to provide the magnification system directly in the tube itself. This ensues, in particular, from the advantageous design of the magnification system itself, for which examples of advantages embodiments will be described in greater detail in the further course of the description.

What is involved in the case of a tube according to the present invention, in general, is an end piece for a viewing device, particularly for a microscope, and, in the case of a swivel tube, a movable end piece, through which the view into the viewing device is made possible. To this end, the tube has at least one optical tube element. Naturally, two or more optical tube elements can also be provided.

An optical tube element can involve, for example, a lens element or a lens element system, consisting of two or more lens elements (for example, in the form of cemented components or the like). For example, an optical tube element might involve an eyepiece. In general, the tube has the function of producing an intermediate image, which can then be observed by using the eyepiece. However, depending on the design of the tube, the eyepiece can also be constructed as an independent, separate component part. Thus, for example, there exist tubes having interchangeable eyepieces or else tubes in which the eyepieces are fixed in place.

The present invention is not limited to certain types of magnification systems. What can be involved here, for example, is a zoom system, a magnification changer (for example, a Galilei changer), or the like. The magnification system is characterized in that, by means of it, a—stepwise or continuously variable—change in the focal depth is possible. This can be realized, for example, by axially shifting the optical elements—for example, the lenses or lens groups—in an optical system. It is equally possible to use lens elements having variable focal depth. So-called vario lenses are in themselves already known from the prior art.

Provided in accordance with the invention is a tube for a viewing device, the invention naturally not being restricted to certain types of viewing devices. Advantageously, the viewing device can involve a microscope. Especially preferably, the tube can be constructed and used as a module for a surgical microscope.

The tube has, first of all, at least one viewing beam path. Advantageously, the tube can have at least two viewing beam paths. When, in addition to a primary viewer, an additional viewer is also to be permitted, it is naturally also possible to provide more than two viewing beam paths. In such a tube, what is involved, for example, is a tube for a stereomicroscope or a so-called binocular tube. The tube can additionally contain optical tube elements.

Provided in accordance with the invention is then, first, that the magnification system is arranged within the tube and is not provided, as was previously common, outside of the tube—for example, in the base unit of the viewing device.

In a surprising way, it was then possible for the first time to integrate the magnification system within the tube. What was only known previously from DE 103 16 242 A1 was to deviate the beam path within the tube for the purpose of a reduction in structural length in such a way that the beam path ran perpendicularly to the optical axis or the axis of the microscope in the entrance region of the tube. A magnification system still had to be arranged, as in the past, in the base unit of the viewing device.

The magnification system in DE 102 55 961 B3 also functions according to the same principle. Here, too, the magnification system is provided within the base unit and accordingly before entrance into the tube.

In accordance with the invention, the arrangement of the magnification system in the tube does not result in an enlargement in its structural length. At the same time, the necessary design space in the base unit of the viewing device is further reduced, so that the complete structural length of the viewing device is further reduced.

Advantageously, the tube can have at least two viewing beam paths, so that preferably one magnification subsystem for changing the focal depth is arranged in each of the viewing beam paths.

In another configuration, it can be provided that the magnification system or that the magnification subsystems or that the connecting beam paths to the magnification subsystems is/are arranged at an angle that is not equal to 0° with respect to the optical axis in the tube. In this way, it is possible to reduce further the required structural space for the tube. In particular, it can be provided for advantageously that the magnification system or that the magnification subsystems is / are arranged orthogonally to the optical axis in the tube.

In another configuration, it can be provided that the magnification system or that the magnification subsystems is/are arranged in the entrance region of the tube. What is involved here in the case of the entrance region is the region that adjoins the base unit of the viewing device.

In another configuration, the at least one viewing beam path can run within the tube in two or more spatial levels. Advantageously, the viewing beam path is located in fact in a projection plane, but not in a spatial plane. This configuration is particularly of advantage in the case when the magnification system or the magnification subsystems is/are are arranged at an angle that is not equal to 0 degrees with respect to the optical axis in the entrance region of the tube.

In particular, it is provided for advantageously that the magnification subsystems are arranged in an opposing manner with respect to each other in the tube in relation to the beam pathway. In the tube according to the invention, in comparison to the solution described in DE 102 55 961 B 1, the optical axes or the magnification subsystems are no longer arranged in a parallel manner but rather in an opposing manner to the observing beam paths (for example, the stereo channels). In such a case, it is necessary for the movement or the shifting of the individual magnification subsystems to occur in a suitable way. How this can happen specifically will be described in greater detail below on the basis of several, non-exclusive examples.

For example, it can be provided that each magnification subsystem has at least one movable optical element and that the at least one movable optical element of the one magnification subsystem is arranged so that it can move independently of the at least one movable optical element of the other magnification system.

In another configuration, it can be provided that each magnification subsystem has at least one movable optical element and that the at least one movable optical element of the one magnification subsystem is arranged so that it can move in a coupled manner with the at least one movable optical element of the other magnification subsystem. Such a coupled shifting can occur mechanically, for example, by using corresponding tracks, spindles, or the like. It is equally possible to realize the shifting in an electrical, hydraulic, pneumatic, or similar manner.

Advantageously, it can be provided that the magnification system takes the form of an apochromatic, afocal magnification system. In this case, in general, “apochromatic” means that color errors can be reduced or eliminated by means of special optical constructions. In this connection, “afocal” means that, in general, it is possible to realize optical systems in which the object and the image lie at infinity.

In an especially advantageous manner, the magnification system can take the form of a zoom system. Such a magnification system—for example, in the form of a pancratic magnification system—makes possible a continuously variable magnification. In cases in which two or more magnification subsystems are provided, these magnification subsystems can advantageously take the form of zoom systems. Naturally, the invention is not limited to these embodiments. For example, the magnification system could also involve a magnification changer, by means of which different magnifications can be set. In many case of application, a stepwise magnification change is fully adequate.

When the magnification system takes the form of a zoom system, it can take the form, for example, of a 2-fold to 8-fold zoom system, the invention not being limited to the examples mentioned.

When the magnification system or the magnification subsystems takes/take the form of an apochromatic, afocal system, it can be designed advantageously in the following way”

| No. | Radius | Thickness | Glass |
|---|---|---|---|
| 1 | 27.2453 | | |
| | | 1.000 | LAFN7 |
| 2 | 14.2007 | | |
| | | 3.000 | NPSK53 |
| 3 | −116.9117 | | |
| | | 1.00 - 12.50 - 18.25 | |
| 4 | −35.0423 | | |
| | | 1.000 | NBAF4 |
| 5 | 10.0995 | | |
| | | 1.500 | NSF6 |
| 6 | 20.1453 | | |
| | | 7.75 - 2.00 - 7.75 | |
| 7 | −20.1453 | | |
| | | 1.500 | NSF6 |
| 8 | −10.0995 | | |
| | | 1.000 | NBAF4 |
| 9 | 35.0423 | | |
| | | 18.25 - 12.50 - 1.00 | |
| 10 | 116.9117 | | |
| | | 3.000 | NPSK53 |
| 11 | −14.2007 | | |
| | | 1.000 | LAFN7 |
| 12 | −27.2453 | | |

Entered in the first column are the face numbers, the second column describes the lens radii, while, in the column “Glass,” the glass designations according to the Schott glass catalog are listed. Between the face numbers 3 and 4, 6 and 7, as well as 9 and 10, values for variable air gaps are given, the value on the left applying to a small magnification, the middle value to a medium magnification, and the value on the right to a maximum magnification.

Advantageously, the magnification system or each magnification subsystem can be constructed in the form of a least one lens element having a variable focal depth. In another configuration, the magnification system or each magnification subsystem can have at least one lens element with a variable focal depth. Involved in the case of lens elements of this kind are so-called vario lenses. Vario lenses are in themselves already known in the most diverse embodiments from the prior art.

An example of a vario lens will be described below. For example, such a lens can have a transparent mounting holder, in which two or more dimensionally stable, non-miscible media are present. Involved here, for example, are liquids, gel-like media, or the like. The media abut each other at their interfaces. This can occur directly through the use of an intervening membrane or the like. External action on at least one of the media—for example, in a hydraulic, pneumatic, electrical, or similar manner—causes the interface between the media to be shifted and this results in a change in the focal depth of the lens. Here, the different media can have the same refractive index or they may have different refractive indices.

As described above, the magnification system, in addition to other optical elements, can be constructed as a separated optical component part. In another configuration, it is also possible that the magnification system or each magnification subsystem has at least one tube lens or at least one tube lens system or else takes the form of a zoom tube lens or else a zoom tube lens system. In this case, it is not necessary for there to be a strict separation between the magnification subsystems and the tube lens or the tube lens system.

Advantageously, it can be provided that, in each viewing beam path of the tube, at least one deviating element is provided in order to deflect the viewing beam path by 180 degrees. What can be involved here, for example, is a mirror, prisms, or the like. When the deviating element takes the form of a prism, it can involve, for example, a 180° prism. Further examples for suitable deviating elements are described in DE 103 16 242 A1, the disclosure content of which is insofar included in the description of the present invention.

Provided that a corresponding deviating element is used, it is possible, for example, for all components of the magnification system or of the magnification subsystems to be arranged in the respective viewing beam path in the beam direction in front of the deviating element. In another embodiment, it is also conceivable that at least one optical element of the magnification system or of the magnification subsystems is arranged in the respective viewing beam path in the beam direction in front of the deviating element and that at least one optical element of the magnification system or of the magnification subsystems is arranged in the respective viewing beam path in the beam direction behind the deviating element.

Especially advantageously, the tube can take the form of a swivel tube.

In a test that was carried out for the magnification subsystems, a 4-fold zoom system (0.5× to 2.0×) having a structural length of 50 mm (diameter of the entrance pupil EP=14 mm) was employed in a swivel tube of the applicant. The total structural length of the complete viewing device, which involves a surgical microscope, could be reduced by about 50 mm. However, the consequence of this was that, depending on the viewing beam path, the tube itself was somewhat wider, although, in view of the problem mentioned above in the introduction of the description, this had no detrimental influence.

Provided in accordance with another aspect is a viewing device comprising a base unit and a tube of the invention as described above. The viewing device can involve, for example, a microscope or the like.

Described in the following by way of example will be a microscope, taking the form of a surgical microscope, in which a corresponding tube in the form of a swivel tube, for example, is realized. A surgical microscope consists, fundamentally, of several component elements, the tube, the base unit, and possibly a stand as well. In addition, it is possible in the case of many surgical microscopes to attach different supplemental modules, such as, for example, a co-viewer tube for an assistant observer, a video camera for documentation, and the like.

Several groups of components can be brought together, in turn, within the base unit, such as, for example, an illumination device, an additional magnification device, the main objective, or the like.

The characteristic magnitude for the main objective is its focal depth, which is set by the working distance from the surgical microscope to the operating field and accordingly has an influence on the total magnification of the microscope.

Further, such a surgical microscope has, as a rule, an eyepiece device, which is either a component part of the tube or else can take the form of a device that is independent of the tube. The function of the eyepiece device is, in general, the post-magnification of the intermediate image produced in the tube as well as possibly the compensation of any defective vision of the user of such a microscope.

The invention will now be described in greater detail on the basis of embodiment examples with reference to the attached drawings. Shown therein are the following:

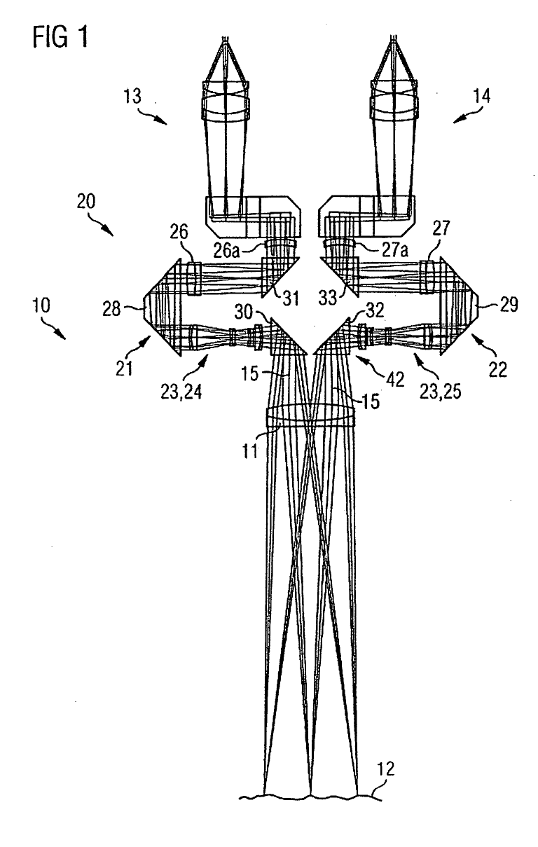

FIG. 1 in schematic depiction, a viewing device taking the form of a stereomicroscope and having a tube of the invention;

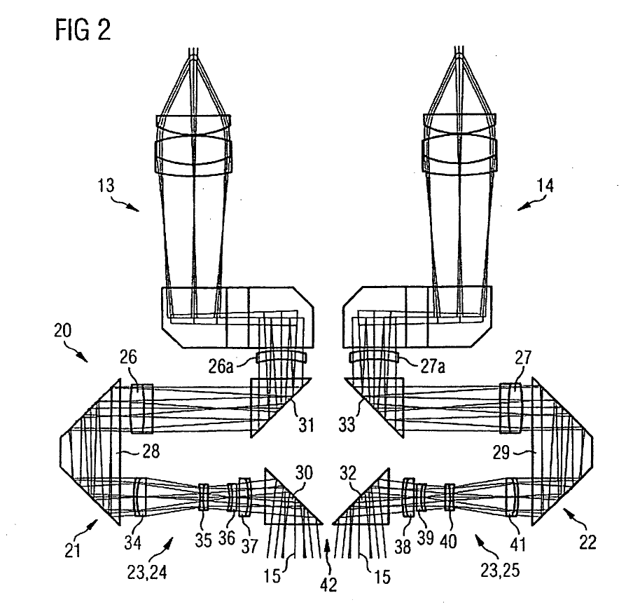

FIG. 2 an enlarged depiction of the tube shown in FIG. 1;

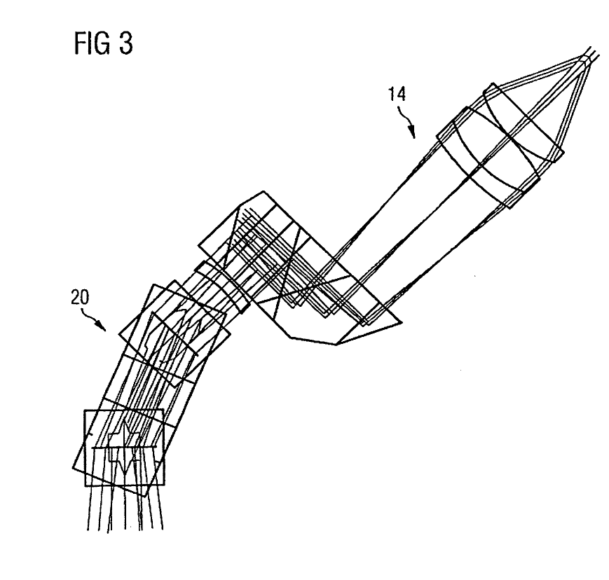

FIG. 3 a schematic depiction of the tube of the invention in a swiveled position of 45°;

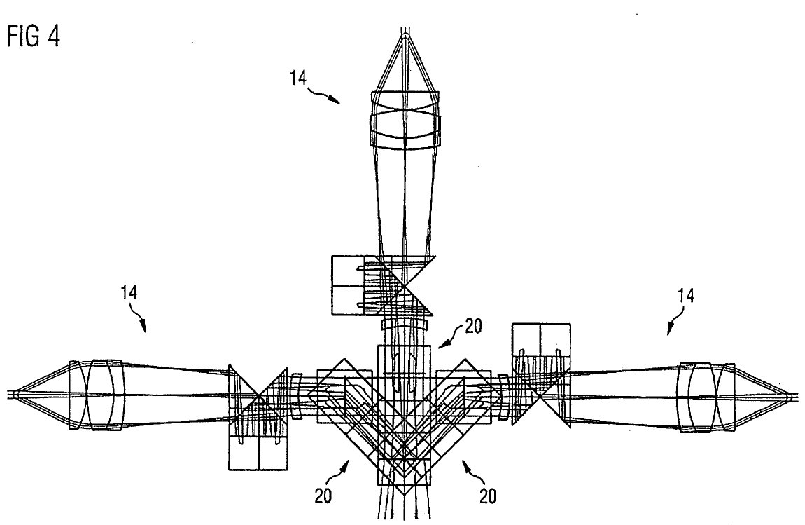

FIG. 4 a schematic depiction of the tube of the invention with a swiveling range of 180°;

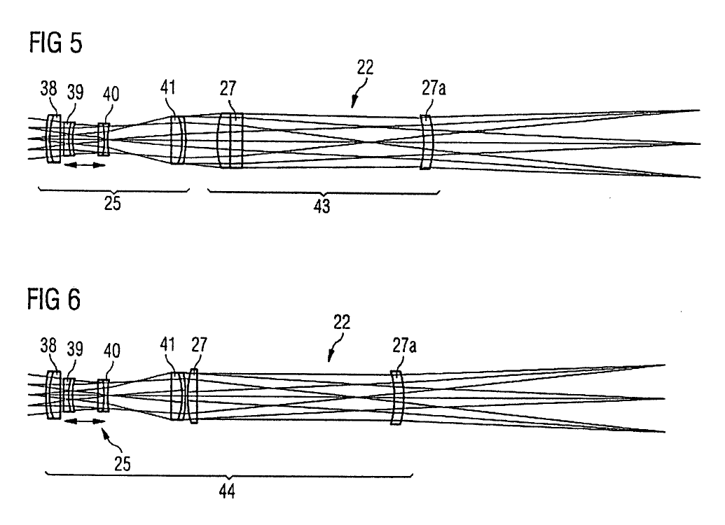

FIG. 5 a schematic depiction of a tube in which the magnification system and the optical tube elements take the form of separated optical systems;

FIG. 6 a schematic depiction of a tube in which the magnification system and the optical tube elements take the form of an optical unit;

FIG. 7 a schematic example in which the magnification system is arranged orthogonally to the optical axis in the entrance region of the tube; and

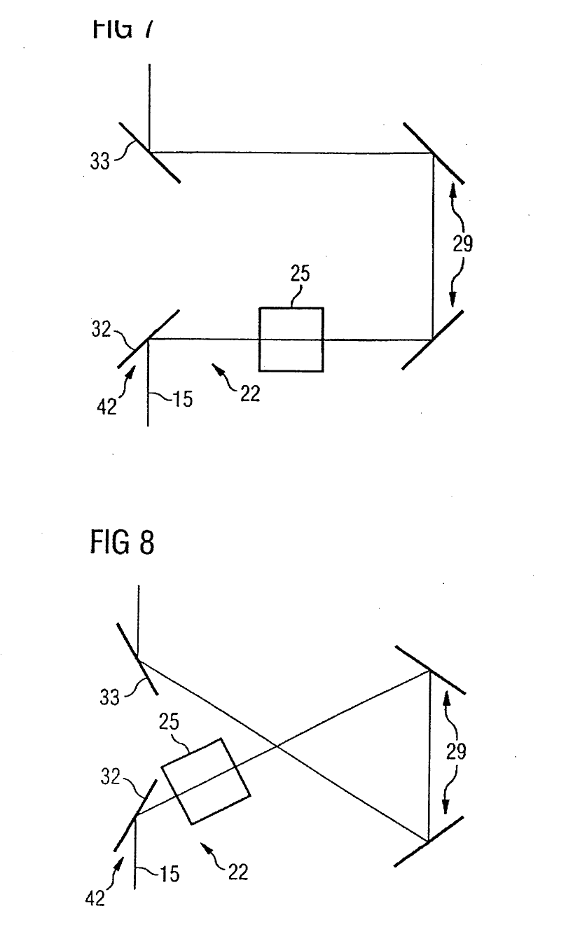

FIG. 8 a schematic example in which the magnification system is arranged at an angle that is not equal to 0 degrees with respect to the optical axis in the entrance region of the tube.

Depicted schematically in FIGS. 1 to 4 is a viewing device 10, taking the form of a surgical microscope, by means of which an object 12 is to be viewed. The surgical microscope 10 first provides, a base unit, which is not depicted in greater detail and in which a main objective 11 is located.

Further, the surgical microscope has a tube 20, which, in the present example, involves a swivel tube. The tube 20 is joined in its entrance region 42 to the base unit of the surgical microscope 10. Further, the tube 20 is joined to eyepiece devices 13, 14. The latter could naturally also be components of the tube 20.

Provided in the entrance region 42 of the tube 20, first of all, are deviating elements 30, 32, which deflect the viewing beam paths 21, 22 within the tube 20. The deviating elements 30, 32, as well as deviating elements described in greater detail further below, can be constructed in the form of prisms, mirrors, and the like.

The deviating elements 30, 32 cause the direction of the viewing beam paths 21, 22 to now run perpendicularly (orthogonally) to the optical axis 15 in the entrance region of the tube 20. The deviation of the viewing beam paths 21, 22 by means of the deviating elements 30, 32 further causes the viewing beam paths 21, 22 to run in an opposing manner to one another in relation to their beam pathway in the tube 20.

The viewing beam paths 21, 22 impinge on further deviating elements 28, 29—for example, 180° prisms—in which the viewing beam paths are deflected by 180 degrees. By means of additional deviating elements 31, 33, the viewing beam paths 21, 22 are finally deflected once more until they run once again parallel to the optical axis 15 and, in this way, are able to enter the eyepiece devices 13, 14.

This configuration of the tube 20 permits its structural length and thus the complete structural length of the surgical microscope 10 to be reduced. The tube 20 possibly becomes somewhat wider, although this is not detrimental in view of the reduction in the total structural length that is to be achieved.

Additional optical elements can be arranged in the viewing beam paths 21, 22. What are involved here are, for example, certain tube lenses or tube lens systems 26, 26a, 27, 27a.

In addition to this, a magnification system 23 is provided in the viewing beam paths 21, 22, namely, in the beam direction in front of the deviating elements 28, 29. The magnification system 23 involves advantageously a zoom system—for example, a 4-fold zoom system.

This magnification system 23 consists, in turn, of two magnification subsystems 24, 25, one magnification subsystem 24, 25 being arranged in each of the viewing beam paths 21, 22. The magnification system 23 is no longer arranged parallel to the optical axis 15, which involves advantageously the microscope axis, but rather is now orthogonal to the optical axis 15.

The magnification subsystems 24, 25 provide a number of optical elements 34 to 41 and at least one optical element of each respective magnification subsystem 24, 25 is arranged so that it can be shifted. It is possible in this way to change the tube focal depth. Moreover, the magnification subsystems 24, 25 are not parallel with respect to the beam pathway, as in the known solutions of the prior art, but rather are arranged in an opposing manner with respect to one another in the tube 20 or in the viewing beam paths 21, 22.

The respective movable optical elements of the individual magnification subsystems 24, 25 can be arranged so that they can move in a coupled manner with one another. In this case, what is meant is that, when one optical element of the magnification subsystem 24 is shifted in the viewing beam path 21, at the same time the optical element corresponding to it in the magnification subsystem 25 is shifted in the viewing beam path 22. Owing to the opposing alignment, however, the movable optical elements are not shifted parallel with respect to one another, but rather in an opposing manner with respect to one another. This means that the optical elements are moved either toward each other or away from each other. This can be realized, for example, by means of a mechanical coupling via tracks, spindles, and the like or else by means of an electrical, pneumatic, hydraulic, or similar coupling.

The arrangement of the magnification system 23 in the tube 20 does not result in an enlargement in its structural length. At the same time, the required structural length of the base unit of the surgical microscope 10 is further reduced, so that, all in all, a further reduction in the complete structural length of the surgical microscope 10 can be achieved.

Especially advantageously, the tube 20 takes the form of a swivel tube, so that the tube can be swiveled into certain positions, such as, for example, the 45° position depicted in FIG. 3. It is then equally possible to swivel the tube 20 into certain regions—for example, in a 180° swiveling range, as depicted in FIG. 4.

Depicted in FIGS. 5 and 6 is a part of the viewing beam path of a tube—for example, the viewing beam path 22 depicted in FIGS. 1 to 4. The viewing beam path 21 could be depicted equally well.

Depicted in the viewing beam path according to FIG. 5 is a magnification subsystem 25 in the form an afocal zoom system, consisting of a number of optical elements 38, 39, 40, 41. In this regard, reference is made as well to FIG. 2. Provided apart from this is a tube lens system having tube lenses 27 and 27a.

Depicted in contrast to this in FIG. 6 is a tube lens system 44 having variable focal depth, in which the magnification system 25 is combined with the optical elements 38, 39, 40, 41 and the tube lenses 27, 27a into a single optical unit. Particularly the optical element 41 of the magnification subsystem and the tube lens 27 can be combined into a single component in the form of individual lenses or else in the form of a lens group, for example.

FIG. 7 shows a schematic example in which the magnification system is arranged orthogonally to the optical axis in the entrance region of the tube. The course of the beam pathway corresponds here to the beam path depicted in FIGS. 1 and 2.

Depicted in turn, for example, is the viewing beam path 22 with the magnification subsystem 25. The viewing beam path 22 is deflected by means of the deviating element 32 in the entrance region 42 of the tube orthogonally to the optical axis 15, passes through the deviating element 29 and subsequently the deviating element 33.

Depicted in contrast to this in FIG. 8 is an embodiment example in which the magnification subsystem 25 is arranged at an angle that is not equal to 0 degrees and not equal to 90 degrees to the optical axis 15 in the entrance region 42 of the tube.

Advantageously provided for in this case is that the viewing beam path 22 runs within the tube in two or more spatial levels, because the beam path intersects at one point in the example depicted. This point of intersection must, however, lie on different spatial levels so that the course of the beam path is not impeded.

### List of Reference Numbers

10 viewing device (surgical microscope)
11 main objective
12 object
13 eyepiece device
14 eyepiece device
15 optical axis
20 tube
21 viewing beam path
22 viewing beam path
23 magnification system (zoom system)
24 magnification subsystem
25 magnification subsystem
26 tube lens (system)
26a tube lens (system)
27 tube lens (system)
27a tube lens (system)
28 deviating element
29 deviating element
30 deviating element
31 deviating element
32 deviating element
33 deviating element
34 optical element of the magnification system
35 optical element of the magnification system
36 optical element of the magnification system
37 optical element of the magnification system
38 optical element of the magnification system
39 optical element of the magnification system
40 optical element of the magnification system
41 optical element of the magnification system
42 entrance region of the tube
43 tube lens system
44 tube lens system with variable focal depth

1. A tube for a viewing device, particularly for a microscope, the tube having at least one viewing beam path and at least one optical tube element being arranged in the viewing beam path, characterized in that a magnification system for changing the focal depth is further arranged in the viewing beam path of the tube.

2. The tube according to claim 1, further characterized in that the tube has at least two viewing beam paths and that a magnification subsystem for changing the focal depth is arranged in each of the viewing beam paths.

3. The tube according to claim 1, further characterized in that the magnification system or that the magnification subsystems or the connecting beam pathways to the magnification subsystems is/are arranged in the tube at an angle that is not equal to 0 degrees with respect to the optical axis.

4. The tube according to claim 3, further characterized in that the magnification system or that the magnification subsystems is/are arranged in the tube orthogonally to the optical axis.

5. The tube according to claim 1, further characterized in that the magnification system or that the magnification subsystems is/are arranged in the entrance region of the tube.

6. The tube according to claim 1, further characterized in that the at least one viewing beam path runs within the tube in two or more spatial levels.

7. The tube according to claim 2, further characterized in that the magnification subsystems are arranged in an opposing manner with respect to each other in the tube in relation to the beam pathway.

8. The tube according to claim 2, further characterized in that each magnification subsystem has at least one movable optical element and that the at least one movable optical element of the one magnification subsystem can move independently of the at least one movable optical element of the other magnification subsystem.

9. The tube according to claim 2, further characterized in that each magnification subsystem has at least one movable optical element and that the at least one movable optical element of the one magnification subsystem can move in a coupled manner with the at least one movable optical element of the other magnification subsystem.

10. The tube according to claim 1, further characterized in that the magnification system takes the form of an apochromatic, afocal magnification system.

11. The tube according to claim 1, further characterized in that the magnification system takes the form of a zoom system.

12. The tube according to claim 11 further characterized in that the zoom system takes the form of a 2-fold to 8-fold zoom system.

13. The tube according to claim 1, further characterized in that the magnification system or each magnification subsystem is constructed in the form of at least one lens element having variable focal depth.

14. The tube according to claim 1, further characterized in that the magnification system or each magnification subsystem has at least one lens element with variable focal depth.

15. The tube according to claim 1, further characterized in that the magnification system or that each magnification subsystem takes the form of at least one tube lens or one tube lens system as a zoom tube lens or zoom tube lens system.

16. The tube according to claim 1, further characterized in that at least one deviating element is provided in each viewing beam path of the tube in order to deflect the viewing beam path by 180 degrees.

17. The tube according to claim 16, further characterized in that all components of the magnification system or of the magnification subsystems are arranged in the respective viewing beam path in the beam direction in front of the deviating element.

18. The tube according to claim 16, further characterized in that at least one optical element of the magnification system or of the magnification subsystems is arranged in the respective viewing beam path in the beam direction in front of the deviating element and that at least one optical element of the magnification system or of the magnification subsystems is arranged in the respective viewing beam path in the beam direction behind the deviating element.

19. The tube according to claim 1, further characterized in that the tube takes the form of a swivel tube.

20. A viewing device, particularly a microscope, having a base unit and having a tube according to one of claims 1 to 19.
